(19) United States
(12) Patent Application Publication
(10) Pub. No.: US 2020/0208592 A1
(43) Pub. Date: Jul. 2, 2020

(54) GASEOUS FUEL FEEDING SYSTEM AND A VALVE

(71) Applicant: WÄRTSILÄ FINLAND OY, Vaasa (FI)

(72) Inventors: Tomas HÖGNABBA, Vaasa (FI); Klaus WIDJESKOG, Vaasa (FI); Marko KUUSISAARI, Vaasa (FI)

(73) Assignee: WÄRTSILÄ FINLAND OY, Vaasa (FI)

(21) Appl. No.: 16/817,058

(22) Filed: Mar. 12, 2020

Related U.S. Application Data
(63) Continuation of application No. PCT/EP2017/072818, filed on Sep. 12, 2017.

(51) Int. Cl. F02M 21/02

(52) U.S. Cl. CPC F02M 21/0242; F16K 27/067; F02M 21/0245

(57) ABSTRACT

A gaseous fuel feeding system having a fuel supply line enclosed by a barrier wall system such that the fuel supply line includes a primary flow channel for the fuel and a secondary flow channel around the primary flow channel inside the barrier wall system, and a valve having a first fluid passage and a second fluid passage arranged to extend through the valve. The valve is coupled between the first and the second fuel supply line sections, such that the primary flow channel in the first fuel supply line section is in controllable flow connection with the primary flow channel in the second fuel supply line section via the first fluid passage of the valve. The secondary flow channel is in continuous flow connection with the secondary flow channel in the second fuel supply line section via the second fluid passage of the valve.

### RELATED APPLICATION

This application claims priority as a continuation application under 35 U.S.C. § 120 to PCT/EP2017/072818 filed as an International Application on Sep. 12, 2017 designating the U.S., the entire content of which is hereby incorporated by reference in its entirety.

### FIELD

The present disclosure relates to a gaseous fuel feeding system, having a fuel supply line enclosed by a barrier wall system such that the fuel supply line includes a primary flow channel for the fuel and a secondary flow channel around the primary flow channel inside the barrier wall system, the fuel supply line having a first fuel supply line section, and a second fuel supply line section and a valve coupled between the first and the second fuel supply line sections.

Also disclosed is a valve having a body and at least two coupling adapters arranged to the body, a plug element disposed in the body and a first fluid passage arranged to extend through the coupling adapters, the body, and the plug element, wherein the plug element is configured to rotate about a radial axis to block or unblock the first fluid passage.

### BACKGROUND INFORMATION

In internal combustion piston engines, for instance in marine vessels, the output of the engines has constantly increased. In case the engine is powered by gaseous fuel, an unavoidable consequence is that the gas pressure in the fuel gas system is also increased. This has its consequences in dimensioning the fuel system components, meaning a need for increasing e.g. wall or material thicknesses to meet the demands set to the strength of the structures.

Fuel systems for feeding gaseous fuel to an internal combustion engine in a marine vessel are commonly constructed such that a fuel supply line runs inside, i.e. is enclosed by a barrier wall system, in order to prevent direct leakage to surrounding should the fuel supply line leak. Still, when the demands to enduring greater gas pressure increase, this also reflects to the demands of the barrier wall system. It is also known to provide such fuel system with a gas valve unit (GVU) before, or upstream the engine, into which certain components of the fuel system, like shut-off valves and pressure regulators, are assembled in centralized manner. Also the GVU includes a barrier wall system to controllably handle possible gas leak. The barrier wall system of the GVU can include a vent line connecting the internal space of the GVU and the surroundings so that gas leakage can be vented out of the GVU in case of failure of the fuel supply line, such as a pipe rupture. However, the gas pressure inside barrier wall system can increase too much due the fact that vent line cannot purge the pressure caused by the leaking gas, and will eventually break the fuel system.

One solution is to increase the material thicknesses of the barrier wall systems. However, this can lead to material thicknesses increasing too massive.

### SUMMARY

A gaseous fuel feeding system is disclosed, comprising: a fuel supply line enclosed by a barrier wall system such that the fuel supply line includes a primary flow channel for fuel and a secondary flow channel around the primary flow channel inside the barrier wall system, the fuel supply line having a first fuel supply line section and a second fuel supply line section; and a valve having a body and at least two coupling adapters arranged to the body, a plug element disposed in the body, and a first fluid passage arranged to extend through the coupling adapters and the plug element of the valve, wherein the plug element is configured to rotate about a radial axis to block or unblock the first fluid passage, the valve having a second fluid passage arranged to extend through the coupling adapters and the body; and wherein the valve is coupled between the first and the second fuel supply line sections, such that the primary flow channel in the first fuel supply line section is in controllable flow connection with the primary flow channel in the second fuel supply line section via the first fluid passage of the valve, and the secondary flow channel in the first fuel supply line section is in continuous flow connection with the secondary flow channel in the second fuel supply line section via the second fluid passage of the valve.

A valve is also disclosed comprising: a body; and at least two coupling adapters arranged relative to the body; and a plug element disposed in the body and a first fluid passage arranged to extend through the coupling adapters, wherein the plug element is configured to rotate about a radial axis to block or unblock the first fluid passage, the valve having a second fluid passage arranged to extend through the coupling adapters and the body.

### BRIEF DESCRIPTION OF THE DRAWINGS

In the following, exemplary embodiments of the invention will be described with reference to the accompanying exemplary, schematic drawings, in which:

FIG. 1 illustrates a fuel feeding system according to an exemplary embodiment of the present disclosure;

FIG. 2 illustrates a first cross-sectional view of the exemplar valve according to an embodiment of the present disclosure;

FIG. 3 illustrates a second cross-sectional view of the valve according to an exemplary embodiment of the present disclosure;

FIG. 4 illustrates a third cross-sectional view of the valve according to an exemplary embodiment of the present disclosure;

FIG. 5 illustrates a face view of the coupling flange according to an exemplary embodiment of the present disclosure; and

FIG. 6 illustrates a flow throttling element of the valve according to an exemplary embodiment of the present disclosure.

### DETAILED DESCRIPTION

A gaseous fuel feeding system is disclosed in which the performance can be considerably improved compared to known solutions by enhancing the pressure control during possible leakage situations.

Exemplary embodiments include a valve by which the performance of gaseous fuel feeding system can be considerably improved compared to known solutions.

A gaseous fuel feeding system as disclosed can include a fuel supply line enclosed by a barrier wall system such that the fuel supply line include a primary flow channel for the fuel and a secondary flow channel around the primary flow channel inside the barrier wall system, the fuel supply line having a first fuel supply line section, and a second fuel supply line section. The gaseous fuel feeding system is provided with a valve according to the present disclosure coupled between the first and the second fuel supply line sections. The primary flow channel in the first fuel supply line section is in controllable flow connection with the primary flow channel in the second fuel supply line section via the first fluid passage of the valve, and the secondary flow channel in the first fuel supply line section is in continuous flow connection with the secondary flow channel in the second fuel supply line section via the second fluid passage of the valve.

According to an exemplary embodiment the system includes a gas fuel tank configured to store the fuel in liquefied form, and a liquefied gas evaporation system, in which fuel feeding system the fuel supply line is arranged to extend from the tank to a gas valve unit arranged in the system, and wherein the valve is arranged to the fuel supply line between the tank and the gas valve unit.

This provides a restrictor for maximum pressure build-up in an enclosed gaseous fuel supply system which performance is considerably improved.

A valve in the gaseous fuel feeding system according to the present disclosure can include a body and at least two coupling adapters arranged to the body, by means of which the valve can be coupled to a gaseous fuel feeding system, and a plug element disposed in the body and a first fluid passage arranged to extend through the coupling adapters and the plug element, wherein the plug element is configured to rotate about a radial axis to block or unblock the first fluid passage, wherein the valve includes a second fluid passage arranged to extend through the coupling adapters and the body. The second fluid passage is fluidly separated from the first fluid passage in the valve.

According to an exemplary embodiment the second fluid passage is arranged to provide a continuous flow connection through the coupling adapters and the body of the valve.

According to an exemplary embodiment the second fluid passage is provided with a flow throttling element.

According to an exemplary embodiment coupling adapters include a circular flange arranged perpendicularly to a center axis of the first fluid passage and the first fluid passage is arranged symmetrically to the center of the flange and the second fluid passage includes at least one opening in the flange at a radial distance from the first passage.

According to an exemplary embodiment the second fluid passage includes more than one openings arranged at a radial distance from the first fluid passage angularly evenly distributed around the first fluid passage in the flange.

According to an exemplary embodiment the flange includes a first sealing rim provided with a sealing surface around the first fluid passage and a second sealing rim provided with a sealing surface circumscribing the one or more openings of the second fluid passage.

According to an exemplary embodiment the valve includes a first flow connection path which opens into the first fluid passage at its first end and into an outer side of the valve at its second end.

According to an exemplary embodiment the first flow connection path is provided with a pressure transmitter.

According to an exemplary embodiment the first flow connection path is arranged relative to the at least one of the coupling adapters of the valve.

According to an exemplary embodiment the valve includes a second flow connection path which opens into the second fluid passage at its first end and into an outer side of the valve at its second end.

According to an exemplary embodiment the second flow connection path is provided with a gas detector.

According to an exemplary embodiment the second flow connection path is arranged relative to the at least one of the coupling adapters of the valve.

According to an exemplary embodiment the body includes a first sleeve and a second sleeve, and the coupling adapters include a coupling flange wherein the first and the second sleeve is arranged to extend between the coupling flanges and the second sleeve is arranged to enclose the first sleeve, and wherein the first fluid passage is arranged inside the first sleeve and the second fluid passage is arranged between the first sleeve and the second sleeve, wherein the plug element is arranged inside the first sleeve.

According to an exemplary embodiment the coupling flanges are attached with each other by means of threaded bolts extending between the flanges in the space between the first sleeve and the second sleeve.

According to an exemplary embodiment the flow throttling element includes a removably assembled ring arranged between the first sleeve and the second sleeve, which is configured to provide a restriction to cross sectional face area in the space between the first sleeve and the second sleeve.

According to an exemplary embodiment the flow throttling element is formed by the openings of the second fluid passage arranged around the first fluid passage in the flange.

The valve can be particularly configured for use in a gaseous fuel feeding system provided with primary flow channel and a secondary flow channel enclosing the primary flow channel.

The exemplary embodiments presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated. The novel features which are considered as characteristic of the invention are set forth in particular in the appended claims.

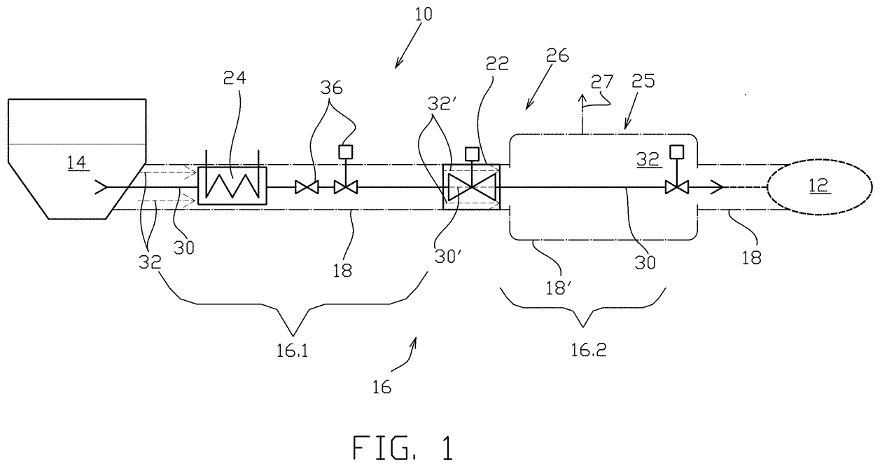

FIG. 1 depicts schematically a gaseous fuel feeding system 10 according to an exemplary embodiment of the present disclosure. It includes a gas fuel tank 14 configured to store the fuel in liquefied form, the fuel being e.g. liquefied natural gas. There is a fuel supply line 16 arranged to extend from the tank 14 to an internal combustion piston engine 12 such that the gas may be delivered to the engine 12 for use as its fuel. The fuel supply line 16 also includes a liquefied gas evaporation system 24, configured to evaporate the liquefied gas into gaseous form and optionally to heat the evaporated gas to a desired temperature. In the fuel feeding system 10, according to an exemplary embodiment of present disclosure, the fuel supply line 16 is arranged to extend from the tank 14 to a gas valve unit (GVU) 25 arranged in the system. The gas valve unit 25 is arranged before the engine 12. The GVU may include several control devices, such as gas pressure regulation device, inside it. The fuel supply line 16 advantageously also includes different types of control devices, such as control valves 36 to control the system, although not described here in detail, advantageously arranged in the gas valve unit 25.

The fuel supply line 16 is provided a primary flow channel 30 for the gaseous fuel, which may be in a form of an inner pipe. The fuel supply line 16 is also provided with a barrier wall system 18 which forms a double wall surrounding the primary flow channel 30. In other words the gas is delivered from the tank 14 to the engine 12 via the inner pipe. Should the inner pipe leak the leaked gas is controllably handled by the space between the primary flow channel 30 and the barrier wall system 18. At such locations, where the fuel supply line 16 is a pipe the barrier wall system is advantageously an outer pipe around the inner pipe. The GVU 25 also includes a barrier wall system 18′ enclosing the gas handling devices inside. The space between the primary flow channel 30 and the barrier wall 18′ system forms a secondary flow channel 32 for the gas. So, the possibly leaked gas is gathered into the secondary flow channel and lead to safe handling of the leaked gas.

According to the present disclosure, the fuel supply line 16 includes successively a first line section 16.1 and a second line section 16.2 and a valve 22, which is advantageously a ball valve, coupled between the first and the second fuel supply line sections 16.1, 16.2. The fuel supply line 16 is enclosed by a barrier wall system 18 such that the fuel supply line 16 includes the primary flow channel 30 for the fuel and the secondary flow channel 32 around the primary flow channel and inside the barrier wall system 18. The primary flow channel 30 in the first fuel supply line section 16.1 is in controllable flow connection with the primary flow channel 30 in the second fuel supply line section 16.2 via a first fluid passage of the ball valve 22. The secondary flow channel 32 in the first fuel supply line section 16.1 is in continuous flow connection with the secondary flow channel 32 in the second fuel supply line section 16.2 via a second fluid passage 32′ of the ball valve 22. The operation and use of the ball valve 22 will be described later in more detailed manner.

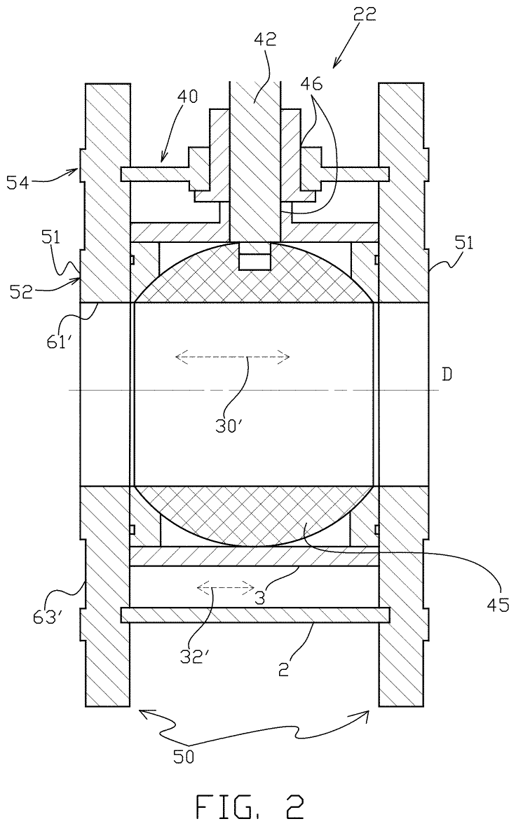

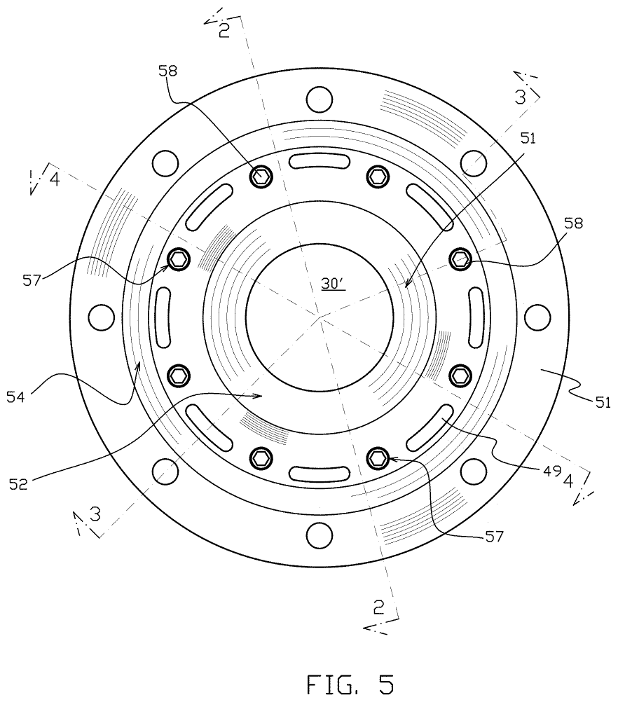

A structure of the ball valve 22 according to an exemplary embodiment of the present disclosure is described in the following with a reference to the FIGS. 2, 3, 4 and 5. FIG. 5 depicts a face view of the ball valve 22 seen perpendicularly to the direction of the first fluid passage 30′. In the Figure 2 there is shown a sectional view 2-2 of the ball valve according to an embodiment of the present disclosure in more detail. The ball valve 22 includes a body 40 and a plug element 45 which is spherical plug element disposed into the body 40. The plug ball 45 is spherical plug which is rotatable inside the valve body 40 around a radial axis to control the flow in the first fluid passage 30′ through the valve 22. The body of the ball valve also includes radially aligned opening 46 and sealing for a stem 42, which is used to control the plug element 45 to rotate about a radial axis to block or unblock the flow in the first fluid passage 30′. The ball valve 22 can be equipped with a pneumatic, hydraulic or electric actuator, but it can also be adjusted manually. The actuator for the valve is located outside of the ball valve 22. The stem and its guiding opening in the body are constructed so that in any case the gas leak through the openings 46 in the body is minimized, e.g. by making use of suitable sealing.

The ball valve 22 includes a first fluid passage 30′ and a second fluid passage 32′. The ball valve 22 further includes coupling adapters 50 arranged to the body 40 by means of which the ball valve 22 can be attached to the fuel supply line 16. The first fluid passage 30′ of the ball valve 22 is arranged to extend through the coupling adapters 50 so as to form a controllable flow connection through the ball valve 22. The second fluid passage 32′ is arranged to extend through the coupling adapters 50 and the body 40 of the ball valve 22 so as to form a second flow connection through the ball valve 22. The second fluid passage 32′ is fluidly separated from the first fluid passage 30′.

Each one of the coupling adapters 50 include a circular flange 51 arranged perpendicularly to a center axis D of the first fluid passage 30′. The flange is arranged to the body of the ball valve such that the first fluid passage 30′ is symmetrical to the center of the flange 51. According to the embodiment shown in the FIG. 2 the valve body 40 further includes a first sleeve 3 and a second sleeve 2 arranged between the coupling adapters 50. The second sleeve 2 is arranged to enclose the first sleeve 3. The first sleeve 3 and the second sleeve 2 are arranged parallel to the center axis D of the first fluid passage. The first fluid passage 30′ is inside the first sleeve 3 and the second fluid passage 32′ is arranged radially between the first sleeve 3 and the second sleeve 2. The plug element 45 is arranged inside the first sleeve 3. In the FIGS. 2-4 the first sleeve 3 and the second sleeve 2 are arranged coaxially with respect to each other. That is not absolutely essential to the invention although it makes is easier to manufacture the ball valve this way. The first and the second sleeves 3, 2 are arranged to extend between the coupling flanges 51.

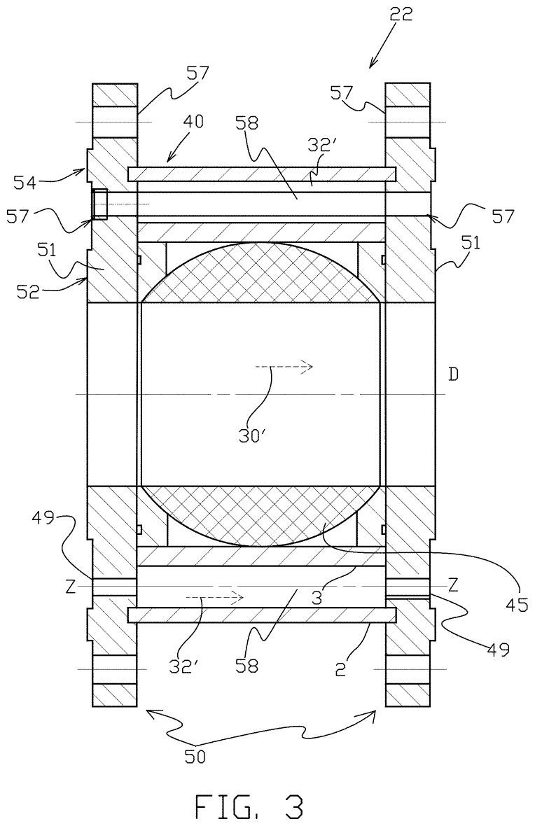

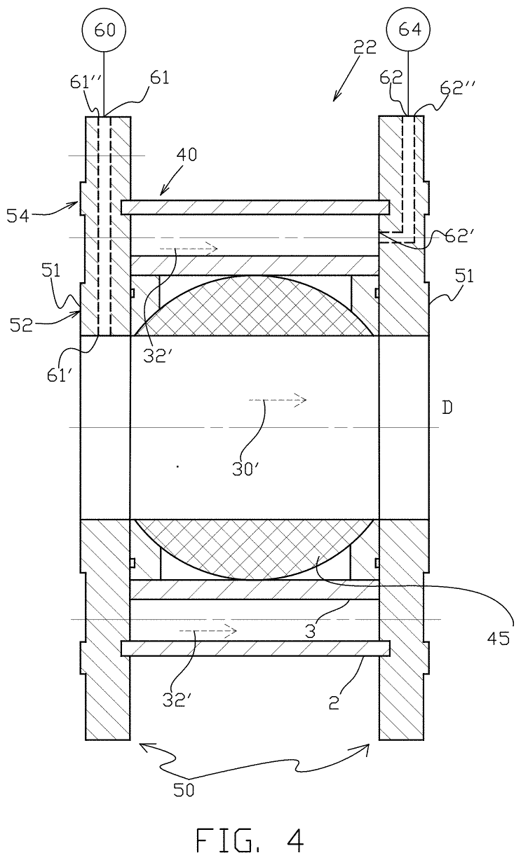

The ball valve 22 includes suitably threaded bolts 58 (see FIGS. 3 and 4) extending between the flanges 51. The coupling flanges are attached with each other by means of bolts 58. Advantageously the threaded bolts 58 (see FIGS. 3 and 4) are arranged to extend between the flanges 51 in the space between the first sleeve 3 and the second sleeve 2.

The ball valve 22 shown in the FIG. 2 can be coupled to the fuel feeding system 10 shown in the FIG. 1 such that the coupling flanges 51 of the ball valve 22 are attached to the fuel supply line 16 with a counterflanges welded into the piping structure of the fuel supply line 16.

In the FIG. 3 there is shown a sectional view 3-3 of the FIG. 5. The ball valve 22 includes openings 49 arranged to the flanges 51 communicating with the second fluid passage 32′ in the body 40 of the valve 22. As can be seen in the FIGS. 3 and 5 the openings 49 of the second fluid passage 30′ in the flange 51 are arranged at a radial distance from the first fluid passage 30′ angularly distributed around the first fluid passage 30′ in the flange 51. The number of openings and the distribution of the openings may vary depending on the case. The openings 49 act as the throttling element. The provides the effect of making it possible to change the throttling effect caused by the openings 49 by changing one of the flanges of the valve 22 to a second one, wherein the local pressure loss coefficient of the second flange is different from that in the first flange.

As is shown in the lower part of the FIG. 3 a line Z-Z depicts a continuous fluid connection for the second fluid passage 32′ to provide a continuous flow connection through the coupling adapters 50 and the body 40 of the ball valve 22 surrounding the first fluid passage 30′ in the body of the valve 22. The flange 51 advantageously includes a first sealing rim 52 provided with a sealing surface around the first fluid passage 30′. In addition, the flange 51 advantageously includes a second sealing rim 54 provided with a sealing surface around the first sealing rim 52. The openings 49 for the second fluid passage 32′ are arranged between the first and the second sealing rims 52, 54 and thus the second sealing rim 52 and its sealing surface circumscribes the openings 49 of the second fluid passage 32′.

Referring to FIG. 3 the ball valve 22 according to an exemplary embodiment of the present disclosure is an assembly of detachable parts, the main parts being the body 40 and the coupling adapters 50. The detachable part are assembled together making use of threaded bolts 58. The coupling adapters 50, and the flanges 51 as a exemplary preferred embodiment of the coupling adapter are provided with openings into which the bolts 58 are secured. The bolts 58 extend through the second fluid passage 32′ in the ball valve 22. The openings 57 for threaded bolts are disclosed in the FIG. 3. Both of sleeves, the inner 3 and outer 2, are axially, in the direction of the center axis D of the first fluid passage 30′, tightened between the coupling flanges 51 by means of bolts 58. According to an exemplary embodiment of the disclosure one of the flanges 51 can be fixed to the valve body e.g. by welding and the other one of the flanges 51 is assembled to the body by means of the threaded bolts 58.

As described above, the primary flow channel 30 in the first fuel supply line section 16.1 is in controllable flow connection with the primary flow channel 30 in the second fuel supply line section 16.2 via the first fluid passage 30′ of the ball valve 22 (see the FIG. 1). In other words, the first fluid passage 30′ is arranged to provide a flow connection through the coupling adapters, i.e. coupling flanges 51, the body 40 and a plug element 45 provided with a fluid passage substantially perpendicularly to the rotational axis of the plug element 45. Thus, the plug element 45 is arranged to control the flow connection by means of its rotational position. The secondary flow channel 32 in the first fuel supply line section 16.1 is in continuous flow connection with the secondary flow channel 32 in the second fuel supply line section 16.2 via the second fluid passage 32′ of the ball valve 22 (see e.g. FIG. 1). In other words, the second fluid passage 32′ is arranged to provide a continuous flow connection through the coupling adapters, i.e. extending through the coupling flanges 51 and the body 40. The second fluid passage 32′ is separate from the first fluid passage 30′ in the valve. Thus it forms a passage parallel to the first fluid passage between the flanges 51.

Now referring back to the FIGS. 2 to 5, according to an exemplary embodiment of the present disclosure, the openings 49 in the flange 51 are advantageously arranged to restrict the flow from the first fuel supply line section 16.1 to second fuel supply line section 16.2 through the valve 22. The openings 49 therefore act as a flow throttling element. The size, form and number of openings 49 is defined and calculated on a case-specific basis. The openings 49 i.e. the flow throttling element provides a local reduction to the face area of the second fluid passage 32′ of the ball valve 22. Advantageously the reduction to the face area is 10-70%.

In the FIG. 5 there is shown a face view of the coupling flange 51 according to exemplary embodiment of the present disclosure. The coupling flange 51 is attached to other coupling flange 51 by means of threaded bolts 58 extending between the flanges 51 in the space between the first sleeve 3 and the second sleeve 2, which can be seen in the FIG. 3. FIG. 5 shows a plurality of openings 57 for the bolts 58 and nuts of the threaded bolts 58. The bolts are for example evenly angularly distributed around the center of the flange 51. The openings 49 for the second fluid passage 32′ are arranged at a radial distance from the first fluid passage 30′. Those are also preferably angularly evenly distributed around the first fluid passage 30′ in the flange 51. It is also an operable option, that the openings 49 are unevenly distributed. The openings 49 can be in the form of various shapes, for example elongated or circular shapes.

Returning back to the FIG. 4, according to an exemplary embodiment of the present disclosure the ball valve 22 includes a first flow connection path 61, which opens into the first fluid passage 30′ at its first end 61′ and into an outer side of the ball valve 22 at its second end 61″. The first flow connection path 61 is arranged relative to the at least one of the coupling flanges 51 of the ball valve 22. If needed or otherwise desired, such can be arranged in more than one of the coupling flanges 51. The first flow connection path 61 is arranged for e.g. measuring or detection purposes. The first flow connection path 61 is provided with a pressure transmitter 60. Pressure measurements may be carried out via the first flow path 61. This allows the operation of the ball valve 22 and the entire system to be controlled. If two flow coupling paths are provided for pressure measurements, a differential pressure can be determined, and then adjusts the function of the ball valve 22, for example.

In the FIG. 4 can also be seen a second flow connection path 62 in the ball valve 22. The ball valve 22 is provided alternatively, or in addition to the first flow connection path 61 the second flow connection path 62, which opens into the second fluid passage 32′ of the ball valve 22 at its first end 61′ and into an outer side of the ball valve 22 at its second end 62″. The second flow connection path 62 is arranged relative to the at least one of the coupling flanges 51 of the ball valve 22. If needed, such can be arranged in more than one of for coupling flanges 51. The second flow connection path 62 is provided with a gas detector and/or a pressure transmitter 64. By means of the second flow connection path 62 and the gas detector / pressure transmitter 64 it is possible to detect if gas has leaked from the primary flow channel 30 to the secondary flow channel 32 of the gaseous fuel feeding system 10. It is also conceivable that several flow connection paths and detectors can be assembled to the ball valve 22, if needed or otherwise desired.

According to exemplary embodiment of the present disclosure, the ball valve 22 is advantageously arranged on the fuel supply line 16 between the tank 14 and the gas valve unit 25 GVU. The location is for example selected so that the location is close to the GVU 25, although the location can be arranged in anywhere on the fuel supply line 16 depending on the need, i.e., where the system requires protection against a pressure increase. Advantageously the ball valve 22 is integrated to the GVU 25. By means of the ball valve 22 according to the invention effects of a leak in the primary flow channel to the pressure development in the secondary flow channel due to sudden increase on the pressure is efficiently limited to a certain sections of the fuel system.

Now, referring back to the FIG. 1, the ball valve 22 according to the invention is advantageously utilized in a gaseous fuel feeding system in a following manner, which is an example of many operational possibilities of the ball valve. Firstly, should there emerge a reason for quick shut-off, like a rupture in the primary flow channel 30 of the first fuel supply line section 16.1, the ball valve 22 is arranged to shut-off the first fluid passage 30′, i.e. the flow communication of the primary flow channel 30 between the first and the second fuel supply line sections 16.1, 16.2, sufficiently quickly. The closure of the ball valve is controlled by monitoring the pressure (or presence of the fuel gas) in the secondary flow channel 32 via the second flow connection path 62 in the gas valve unit 25 and should the pressure in the secondary flow channel rise over a predetermined pressure the primary flow channel 30′ of the ball valve 22 is precautionary closed. If the leak is in the first fuel supply line section 16.1 i.e. on the tank side of the ball valve 22, the leaked gas continues to flow into the secondary flow channel 32 of the gas valve unit 25 through the second fluid passage 32′ of the ball valve 22. The flow rate through the second fluid passage 32′ is kept restricted by the flow throttling element 56 in second fluid passage 32′ of the valve. The gas valve unit 25 includes a vent channel 27 which open in the secondary flow channel 32 via which a certain flow rate of gas can be obtained and the flow rate into the gas valve unit is restricted by the flow throttling element 56 the pressure rise in the GVU is thus kept moderate and the construction of the gas valve unit can be dimensioned to endure lower pressure level. Thus, the flow rate of the leaking gas in the secondary flow channel 32 is considerably lower so that it will not cause damages to the GVU 25 and the barrier wall system 18′ of the GVU. This way, if the primary fuel supply line is ruptured, the fuel gas rapid flow via the secondary flow channel into the barrier wall system of the GVU can be prevented.

As a further example, if there is a rupture in the primary flow channel 30 after the ball valve 22, the ball valve 22 according the embodiment of the invention will close the primary flow channel 30 of the fuel supply line 16 within a prescribed time limit calculated by maximum pressure build-up rate and allowed maximum pressure in the gas valve unit. In this way, the gas flow to the GVU 25 is cut if the pipe rupture is after the valve 22.

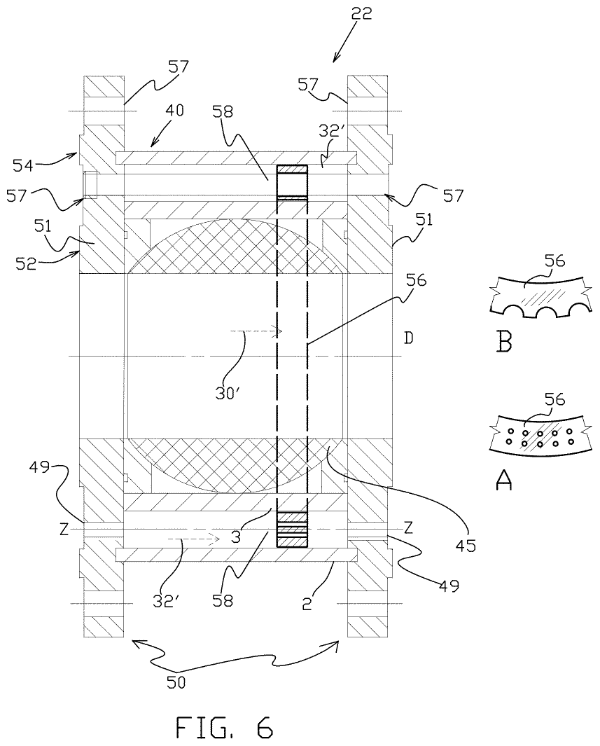

According to another exemplary embodiment of the present disclosure, the second fluid passage 32′ is provided with a separate flow throttling element 56 as is shown in the FIG. 6. The flow throttling element includes one or more removably assembled throttle ring 56 arranged radially between the first sleeve 3 and the second sleeve 2. The throttling ring 56 is held at its position by means of the bolt 58. The ring is configured to provide a restriction to cross sectional face area in the space between the first sleeve 3 and the second sleeve 2 in the body. According to a an exemplary embodiment of the invention the throttling ring 56 provides a local reduction of 10-70% to the face area of the second fluid passage 32′ of the ball valve 22. The throttling effect can be accomplished by various ways; the ring may be provided with axial openings as is shown in the detail A or the ring may be provided with one of more radial cut-outs as is shown in the detail B. The ring may also be constructed from axially stacked mesh elements (not shown). The flow throttling element provides a local pressure loss which limits the pressure raise rate in the gas valve unit GVU.

While the invention has been described herein by way of examples in connection with what are, at present, considered to be the most exemplary embodiments, it is to be understood that the invention is not limited to the disclosed embodiments, but is intended to cover various combinations or modifications of its features, and several other applications included within the scope of the invention, as defined in the appended claims. The details mentioned in connection with any embodiment above may be used in connection with another embodiment when such combination is technically feasible.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A gaseous fuel feeding system, comprising:
a fuel supply line enclosed by a barrier wall system such that the fuel supply line includes a primary flow channel for fuel and a secondary flow channel around the primary flow channel inside the barrier wall system, the fuel supply line having a first fuel supply line section and a second fuel supply line section; and
a valve having a body and at least two coupling adapters arranged to the body, a plug element disposed in the body, and a first fluid passage arranged to extend through the coupling adapters and the plug element of the valve, wherein the plug element is con figured to rotate about a radial axis to block or unblock the first fluid passage, the valve having a second fluid passage arranged to extend through the coupling adapters and the body; and
wherein the valve is coupled between the first and the second fuel supply line sections, such that the primary flow channel in the first fuel supply line section is in controllable flow connection with the primary flow channel in the second fuel supply line section via the first fluid passage of the valve, and the secondary flow channel in the first fuel supply line section is in continuous flow connection with the secondary flow channel in the second fuel supply line section via the second fluid passage of the valve.

2. A gaseous fuel feeding system according to claim 1, wherein the fuel feeding system comprises:
a gas fuel tank configured to store the fuel in liquefied form, and a liquefied gas evaporation system, in which fuel feeding system the fuel supply line is arranged to extend from the tank to a gas valve unit arranged in the system, and wherein the valve is arranged to the fuel supply line between the tank and the gas valve unit.

3. A gaseous fuel feeding system according to claim 1, wherein the second fluid passage in the valve is provided with a flow throttling element.

4. A gaseous fuel feeding system according to claim 1, wherein the second fluid passage is arranged to provide a continuous flow connection through the coupling adapters and the body.

5. A gaseous fuel feeding system according to claim 1, wherein coupling adapters comprise:
a circular flange arranged perpendicularly to a center axis of the first fluid passage, and the first fluid passage is arranged symmetrically to the center of the flange; and the second fluid passage comprises:
at least one opening in the flange at a radial distance from the first fluid passage.

6. A gaseous fuel feeding system according to claim 1, wherein coupling adapters comprise:
a circular flange arranged perpendicularly to a center axis of the first fluid passage; and the second fluid passage comprises:
more than one opening arranged at a radial distance from the first fluid passage angularly distributed around the first fluid passage in the flange.

7. A gaseous fuel feeding system according to claim 1, wherein the flange comprises:
a first sealing rim provided with a sealing surface around the first fluid passage and a second sealing rim provided with a sealing surface circumscribing the one or more openings of the second fluid passage.

8. A gaseous fuel feeding system according to claim 1, wherein the valve comprises:
a first flow connection path which opens into the first fluid passage at its first end and into an outer side of the valve at its second end.

9. A gaseous fuel feeding system according to claim 8, wherein the first flow connection path comprises:
a pressure transmitter.

10. A gaseous fuel feeding system according to claim 8, wherein the first flow connection path is arranged relative to the at least one of the coupling adapters of the valve.

11. A gaseous fuel feeding system according to claim 8, wherein the valve comprises:
a second flow connection path which opens into the second fluid passage at its first end and into an outer side of the valve at its second end.

12. A gaseous fuel feeding system according to claim 11, wherein the second flow connection path comprises:
a gas detector.

13. A gaseous fuel feeding system according to claim 11, wherein the second flow connection path is arranged relative to the at least one of the coupling adapters of the valve.

14. A gaseous fuel feeding system according to claim 1, wherein the body comprises:
a first sleeve and a second sleeve, and the coupling adapters include a coupling flange wherein the first sleeve is arranged to extend between the coupling flanges and the second sleeve is arranged to enclose the first sleeve; and
wherein the first fluid passage is arranged inside the first sleeve and the second fluid passage is arranged between the first sleeve and the second sleeve, wherein the plug element is arranged inside the first sleeve.

15. A gaseous fuel feeding system according to claim 1, wherein the coupling flanges are attached with each other by threaded bolts extending between the flanges in a space between the first sleeve and the second sleeve.

16. A gaseous fuel feeding system according to claim 3, wherein the flow throttling element comprises:
a removably assembled ring arranged between the first sleeve and the second sleeve, which is configured to provide a restriction to a cross sectional face area in a space between the first sleeve and the second sleeve.

17. A gaseous fuel feeding system according to claim 5, wherein the flow throttling element comprises:
one or more openings of the second fluid passage arranged relative to the flange.

18. A valve comprising:
a body; and
at least two coupling adapters arranged relative to the body; and
a plug element disposed in the body and a first fluid passage arranged to extend through the coupling adapters, wherein the plug element is configured to rotate about a radial axis to block or unblock the first fluid passage, the valve having a second fluid passage arranged to extend through the coupling adapters and the body.

19. A valve according to claim 18, wherein the second fluid passage comprises:
a flow throttling element.

20. A valve according to claim 18, wherein the second fluid passage is arranged to provide a continuous flow connection through the coupling adapters and the body.

21. A valve according to claim 18, wherein coupling adapters comprise:
a circular flange arranged perpendicularly to a center axis of the first fluid passage and the first fluid passage is arranged symmetrically to the center of the flange, and the second fluid passage includes at least one opening in the flange at a radial distance from the first fluid passage.

22. A valve according to claim 21, wherein the second fluid passage comprises:
more than one opening arranged at a radial distance from the first fluid passage angularly distributed around the first fluid passage in the flange.

23. A valve according to claim 21, wherein the flange comprises:
a first sealing rim provided with a sealing surface around the first fluid passage and a second sealing rim provided with a sealing surface circumscribing the one or more openings of the second fluid passage.

24. A valve according to claim 18, wherein the valve comprises:
a first flow connection path which opens into the first fluid passage at its first end and into an outer side of the valve at its second end.

25. A valve according to claim 24, wherein the first flow connection path comprises:
a pressure transmitter.

26. A valve according to claim 24, wherein the first flow connection path is arranged relative to the at least one of the coupling adapters of the valve.

27. A valve according to claim 18, wherein the valve comprises:
a second flow connection path which opens into the second fluid passage at its first end and into an outer side of the valve at its second end.

28. A valve according to claim 27, wherein the second flow connection path comprises:
a gas detector.

29. A valve according to claim 27, wherein the second flow connection path is arranged relative to the at least one of the coupling adapters of the valve.

30. A valve according to claim 18, wherein the body comprises:
a first sleeve and a second sleeve, and the coupling adapters include a coupling flange wherein the first and the second sleeve is arranged to extend between the coupling flanges and the second sleeve is arranged to enclose the first sleeve, and wherein the first fluid passage is arranged inside the first sleeve and the second fluid passage is arranged between the first sleeve and the second sleeve, wherein the plug element is arranged inside the first sleeve.

31. A valve according to claim 30, wherein the coupling flanges are attached with each other by threaded bolts extending between the flanges in a space between the first sleeve and the second sleeve.

32. A valve according to claim 19, wherein the flow throttling element comprises:
a removably assembled ring arranged between the first sleeve and the second sleeve, which is configured to provide a restriction to a cross sectional face area in a space between the first sleeve and the second sleeve.
